(19) United States
(12) Patent Application Publication
(10) Pub. No.: US 2015/0199611 A1
(43) Pub. Date: Jul. 16, 2015

(54) METHOD AND SYSTEM FOR PERFORMING REFLEXIVE GAME THEORY (RGT) INFERENCE

(71) Applicant: Sergey Trasenko, Tokyo (JP)

(72) Inventor: Sergey Trasenko, Tokyo (JP)

(73) Assignee: NEC CORPORATION, Minato-ku, Tokyo (JP)

(21) Appl. No.: 14/423,760

(22) PCT Filed: Aug. 27, 2012
(86) PCT No.: PCT/JP2012/005351

§ 371 Date: Feb. 25, 2015

(51) Int. Cl. G06N 7/00

(52) U.S. Cl. CPC G06N 7/00

(57) ABSTRACT

The present invention is a method of performing Reflexive Game Theory (RGT) inference comprising: pre-computing of possible group structure and real-time selecting (template matching) of the group templates by using the input information.

### TECHNICAL FIELD

The present invention relates to a method and a system for performing Reflexive Game Theory inference.

### BACKGROUND ART

Reflexive Game Theory (RGT) enables prediction of group members (subjects) decisions. This analysis is based on only relationships (conflict or alliance) between subjects (individuals, teams or work groups, companies, etc.) and their mutual influences Non-Patent Documents 1 and 2. Conventional inference algorithm and example of RGT inference are presented in FIGS. 1 and 2, respectively. The groups of subjects are presented in the form of fully connected graphs. The graph can have dashed-line ribs (conflict relationships) and solid-line ribs (alliance relationships). The stages of RGT analysis (inference) based on symbolic computations are:

1) input group structure as pair-wise relations between subjects (11);

2) input subjects mutual influences (12);

3) check graphs decomposability (13);

4) construct a polynomial (14);

5) perform Diagonal Form Transformation (DFT)(15);

6) build decision equations (16);

7) perform transformation of the decision equation into canonical form (TDECF) to solve decision equation, obtain templates of decision intervals for each subject (17);

8) input mutual influences into the templates to get possible decisions (18).

### CITATION LIST

### Non Patent Literature

### [NPL 1]

Lefebvre, V. ALectures on Reexive Game Theory, Cogito-Centre, Moscow, 2009.

### [NPL 2]

V. ALectures on Reexive Game Theory, Leaf & Oaks Publishers, 2010.

### SUMMARY OF INVENTION

### Technical Problem

During each RGT inference the DFT and TDECF should be performed. Both DFT and TDECF are iterative procedures, which involve non-trivial operations (FIG. 2). On the other hand, for the group of three subjects, there are only 8 different graphs (group structures). This is illustrated in the left part of FIG. 3. Therefore, repetitions of both transformations create redundancy of calculations and increase overall computation time.

This problem can be solved by pre-computing templates of decision results for each group and just input actual parameters into the templates each time. However, the number of different graphs (group structures) grows exponentially as 2^{n(n-1)/2}, where n is a number of group members (subjects). Thus for groups of four and five subjects there are 64(=2⁶) and 1024(=2¹⁰) different graphs, respectively. I call this straight-forward pre-computation. Therefore, the straight-forward pre-computation results in combinatorial burst and drastic increase in storage size.

Since I have to store a template of decision interval for each subject, the total memory (storage) size required to store pre-computed template is MemSize=n2^{n(n-1)/2}.

Therefore, there are two problems: 1) computational redundancy when using standard approach; and 2) combinatorial burst causing drastic increase in storage size when using straight-forward pre-computation.

### Solution to Problem

The present invention is a method of performing Reflexive Game Theory (RGT) inference comprising: pre-computing of possible group structure and real-time selecting (template matching) of the group templates by using the input information.

The present invention is a method of processing the actual input data for RGT inference by using pre-computed templates comprising: identifying a certain template corresponding to the input data by unique structure features; and identifying location of each subject by means of position feature.

The present invention is a system of performing Reflexive Game Theory (RGT) inference comprising: pre-computing module that pre-computes possible group structure, and real-time selecting module that real-time selects (template matching) the group templates by using the input information.

The present invention is a system of processing the actual input data for RGT inference by using pre-computed templates comprising: module that identifies a certain template corresponding to the input data by unique structure features; and module that identifies location of each subject by means of position feature.

### Advantageous Effects of Invention

The present invention makes it possible to avoid redundancy of computation and reduce the memory size required.

### BRIEF DESCRIPTION OF DRAWINGS

FIG. 1 is a block diagram showing the functional structure of the conventional RGT inference.

FIG. 2 is explanatory diagram showing example of conventional RGT inference.

FIG. 3 is explanatory diagram showing example of generalization procedure.

FIG. 4 illustrates examples of non-decomposable graphs.

FIG. 5 illustrates examples of sub-classes for class Cl (k=2; n=4).

FIG. 6 illustrates example of generalization procedure for the group of four members, indicating classes, sub-classes and graph types.

FIG. 7 illustrates example of how to make Templates of Decision Intervals.

FIG. 8 is a flow chart for Module 1.

FIG. 9 is a block diagram showing the general schema of invention.

FIG. 10 is a block diagram showing the general schema of invention to be realized by means of hierarchical LUT.

FIG. 11 is an explanatory diagram showing example of hierarchical LUT.

FIG. 12 is a block diagram showing the exemplar schema of invention to be realized by means of hierarchical LUT.

FIG. 13 is a block diagram showing example of data flow when invention based on hierarchical LUT is used for RGT inference.

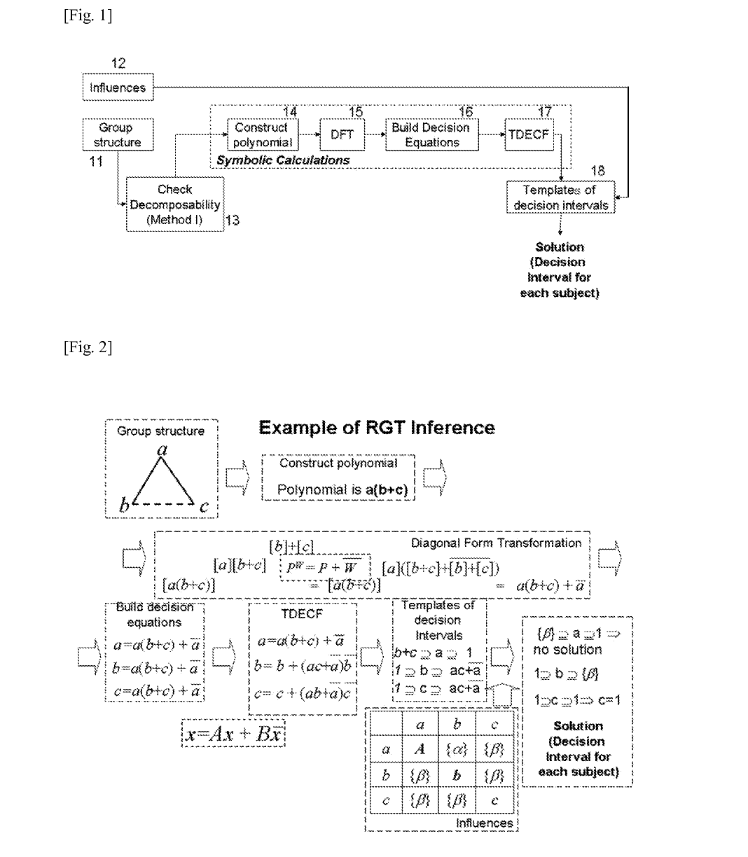

### DESCRIPTION OF EMBODIMENTS

The invention aims to solve both problems of computational redundancy and exponential growth by providing a trade-off between number of operations and storage size

To avoid the computational redundancy and achieve smaller size of the storage, pre-computation method different from the straight-forward computation is used.

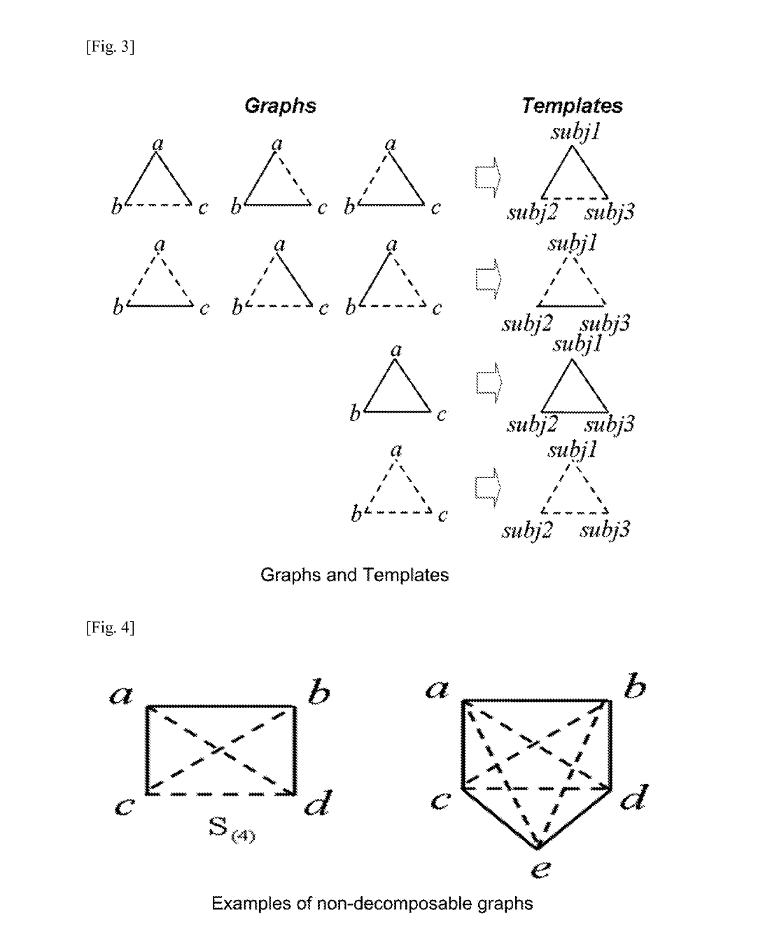

The present method uses classification of the graphs for the given number of subject. For examples, in the case of three subjects, there can be 8 different graphs. These 8 graphs can be generalized to extract four different graph classes regarding the number of alliance and conflict relationships (rib types) in a group. The original 8 graphs are shown in the left part and the graph templates (classes) are shown in the right part of the FIG. 3.

In the case of four group members, the generalization procedure of the graph is slightly more complex. First, for groups of four members, there can be non-decomposable graphs, which cannot be processed by means of RGT. The non-decomposable graph S₍₄₎ for the group of four members is presented in the left part of FIG. 4.

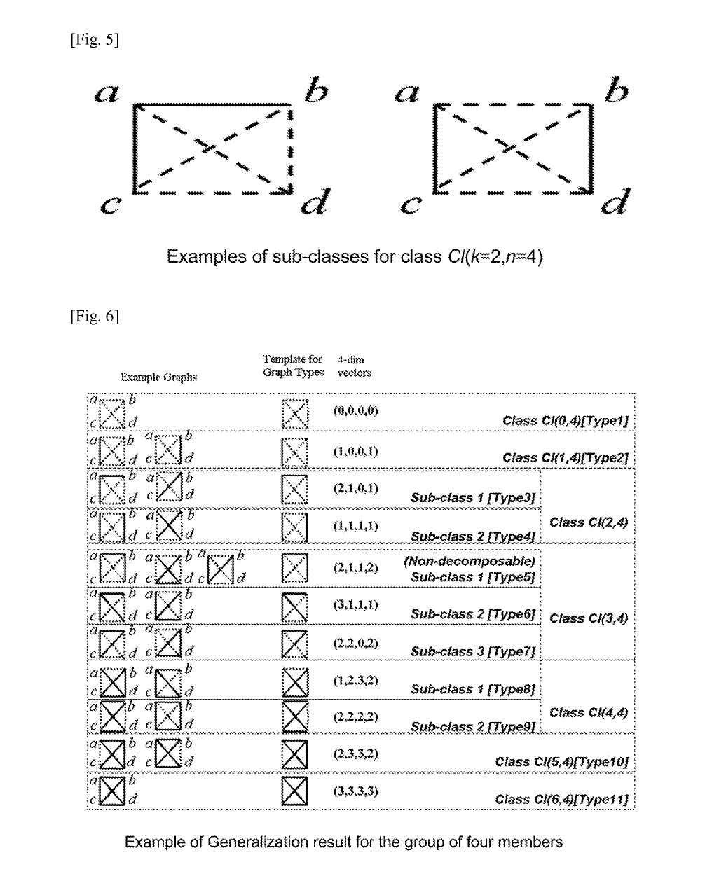

Second, there can be sub-classes in the given class. The example of sub-classes for the class with two alliance relationships is shown in FIG. 5.

In FIG. 6, the result of generalization procedure in the case of a group of four members is presented. The general notification of the class is Cl(k;n), where k is a number of alliances (solid lines), and n is a number of group members.

The left part of FIG. 6 represents examples of graphs of each type, the center part indicate the graph Templates and associated 4-dim vectors (see below for description). The right part illustrates distinction between classes, sub-classes and types. The important difference between actual graphs and templates is that in the former one actual subject variables are assigned to the graph vertices, while template contains no information about actual subject variable. Therefore, I have to relate the vertices of the actual input graph to the ones of the corresponding template.

Next I present the general structure based on the proposed idea of graph classification.

Each group of subjects (graph) is characterized by number of subjects and the relationships between them. Each subject is represented as a single vertex of a graph. The dashed ribs represent conflict relationships, and solid ribs represent the alliance relationships.

I consider n-dim vector (FIG. 6), where n is a number of group members, which shows number of solid ribs connected to the given vertex. Therefore, such vector is an algebraic representation of a group (graph). For example, let (as, bs, cs, . . . ), xs—is a number of solid lines for subject x. In other words, xs is a Number of Alliances (NoA) for subject x.

This vector is directly related to the structure of the actual graph. In reality, a set of 4-dim vector correspond to a particular graph type. Therefore, I need a feature which can provide intra-class invariance and inter-class separability: the value of this feature for different graphs of the same type is the same, but feature values corresponding to the different classes are different.

Using such vector I calculate the feature values to uniquely identify each template. The feature is a 2-dim vector:

Feat=(Sum+Max+Min+cntMin;Sum+Max+Min+cntMax) (1)

where Sum=as +bs+cs+ . . . , Max=max{as; bs; cs; . . . }, Min=min{as; bs; cs; . . . }, and cntMin and cntMax represent the number of Min and Max values, respectively, in the vector.

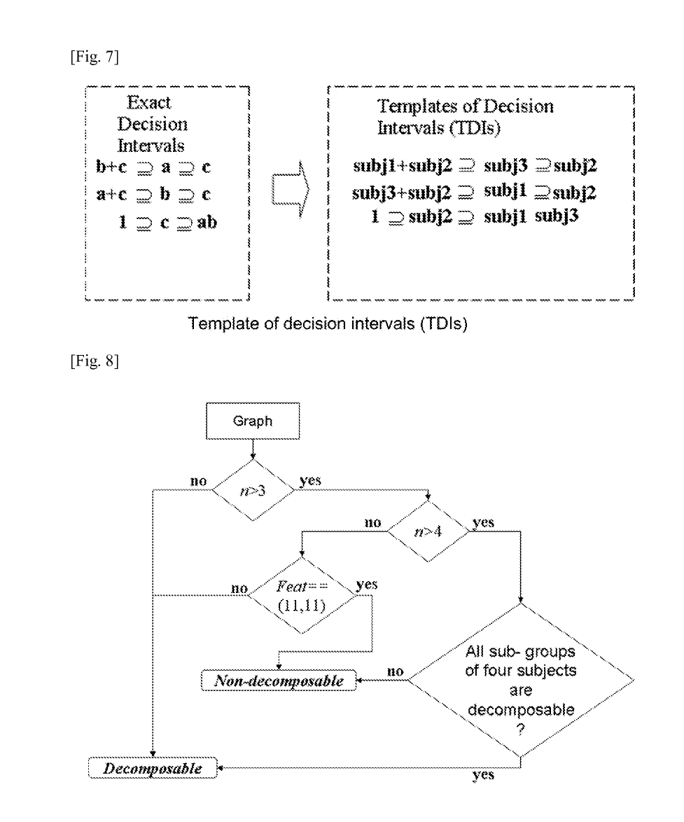

Each template has n corresponding decision intervals. Since the decision intervals are no longer linked to particular subjects, the decision intervals are formulated in terms of abstract subject variables subj1, subj2, etc. I call these intervals to be templates of decision intervals (TDIs).
For example, for group ab+c the decision intervals are b+c⊃c⊃a⊃c, a+c⊃b⊃c and 1⊃c⊃ab. The corresponding TDIs are subj1+subj2⊃subj3⊃subj2, subj3+subj2⊃subj3⊃subj2 and 1⊃D subj2⊃subj1 subj3 (FIG. 7).

To relate the vertices of the input graph to the selected template I use second feature for each vertex. This feature (Feat1) is NoA of the given vertex (subject). The general structure of the present invention based on the original pre-compotation method includes the following modules: 1) module 1—check graph decomposability; 2) module 2—identify the graph type (template), which fits the given group structure; 3) module 3—relate vertices of the input graph to the one of the template's (bind real subjects and abstract subjective variables); 4) module 4—calculate values for decision intervals.

Module 1. For three subjects, there can be no non-decomposable groups. In the case of four subjects, there is one non-decomposable graph (S₍₄₎)(FIG. 4, left part). The feature that uniquely identifies S₍₄₎ is Feat=(11; 11). When there are more than four subjects (n>4), all the non-decomposable graphs contain the sub-graph isomorphic to the S₍₄₎. Therefore, I have to consider all possible sub-graphs and calculate Feat value for each of them. If there are no non-decomposable sub-graph, Feat value (11;11) should not appear. The flow chart for Module 1 is presented in FIG. 8.

Module 2. If the group is decomposable, it is possible to uniquely identify the template for the graph by using Feat value. Each template has associated Feat value. The Feat values for the graph and the stored templates are compared element-wise.

Module 3. Each template of a graph has TDIs associated with it. To bind the actual subjects (a, b, c, etc.) to the abstract subject variables (subj1, subj2, subj3, etc.), the vector elements xs, x is either of a, b, c, etc., are used as features. Here I consider sample case. Let the group contains four subjects a, b, c and d, and the corresponding vector is (1,2,0,1). That means that subject b is in alliance with subjects a and d, who are in conflict with each other. Subject c is in conflict with other subjects. This group is described by polynomial b(a+d)+c.

Each abstract subject variable has associated feature value. The feature (Feat1) is number of connected solid ribs (xs). Let, Feat1(subj1)=2, Feat1(subj2)=0, Feat1(subj3)=1 and Feat1(subj4)=1. Using Feat1, it is possible uniquely identify that subj1 is subject b, subj2 is subject c.

On the other hand, both subj3 and subj4, and a and d, have the same associated value 1. But, in this case the decision intervals for subject subj3 and subj4 are symmetric:

subj1+subj2 not(subj1)⊃subj3⊃subj1+subj2 not(subj1) (2)

subj1+subj2 not(subj1)⊃subj4⊃subj1+subj2 not(subj1) (3)

Therefore, subjects a and d can be arbitrarily associated with the abstract subjects subj3 and subj4.

Module 4. Once the actual subjects are bound to the abstract ones, it is possible to calculate the values for limits of the templates of decision intervals, by inputting the influences from the influence matrix. A user should fill in the influence matrix before implementing the RGT inference. The values from influence matrix are input into the TDIs corresponding to the template.

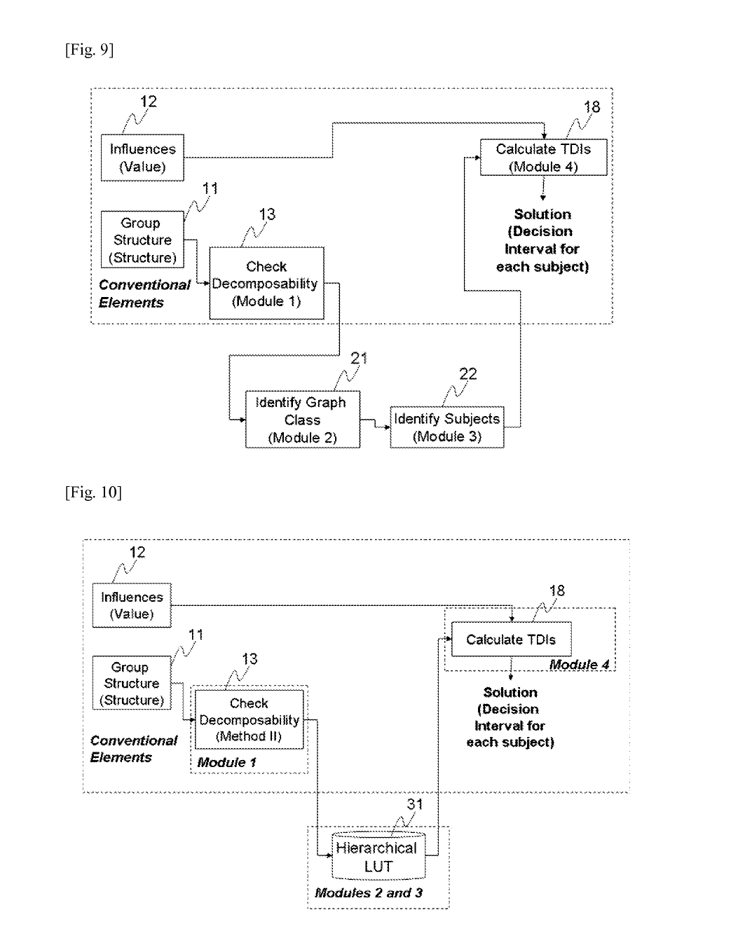

The general schema of invention is presented in FIG. 9.

The present invention is based on the template matching approach: 1) I use a special feature, which can be calculated for each template; and 2) unique values are associated with each template.

The exploitation of the present invention implies two phases.

During the off-line (preparation) phase, the required templates and corresponding feature values are stored in the memory units system or device.

When RGT inference is performed (on-line phase), the values of features are calculated on the basis of input data in real-time and compared with the feature values associated with each template in memory.

During the off-line phase, the templates (graph classes and sub-classes) are obtained by generalization of graphs using methods of combinatorics.

The total number of graphs of the given class Cl(k; n) is C^{k}_{n(n-1)/2}, where

$${C}^{k} n ( n - 1 ) / 2 = \frac{( n ( n - 1 ) / 2 ) !}{( n ( n - 1 ) / 2 - k ) ! k !}$$

is a number of all permutations for k out of n(n−1)/2.

The total number of classes (TNC) is given by formula:

TNC=n(n−1)/2+1 (4)

For k>1, there are possible sub-classes regarding mutual location of the ribs in a graph. For example, for k=2, there are two sub-classes (FIG. 5).

The graphs belonging to different sub-classes are not isomorphic. The graphs belonging to different classes are also not isomorphic. Consequently, graphs belonging to the sub-classes of different classes are also not isomorphic.

Therefore, I consider graph types—each sub-class of any class is considered to be a distinct graph type.

Finally, there is a big class of graphs, which cannot be processed in RGT. These graphs are called non-decomposable graphs (FIG. 4). The non-decomposable graphs can be found as sub-class of the classes,
when k≧3.

In the case of k=3 and n=4, there is a single non-decomposable graph called S₍₄₎ (FIG. 4).

I consider the non-decomposable graphs as a separate independent class (type). Therefore, formula 7 is updated to:

TNC=n(n−1)/2+2 (5)

The overall total number of types (TNT) is a sum of sub-classes for each class plus one (a type for non-decomposable graphs):

$$TNT ( n ) = {\sum }_{k = 0}^{n ( n - 1 ) / 2} TNS ( k ) + 1 \qquad ( 6 )$$

where TNS(k) is a total number of sub-classes for the given class Cl(k; n), excluding sub-classes containing non-decomposable graphs. TNS(k) can be calculated by means of combinatorial methods in each particular case.

The overall memory size (MemSize) required to store all graph types and their corresponding TDIs for the given n is

MemSize=nTNT(n) (7)

The present invention allows to the avoid redundancy of computation and reduce the memory size required.

The present invention allows to sufficiently reduce the size of the storage required. For example, TNT(3) is 4, TNT(4) is 11, and TNT(5) is 25, while corresponding numbers for straight-forward pre-computing are 8, 64 and 1024, respectively.

The corresponding MemSize values to store all required graphs types and corresponding TDIs for groups of three, four and five subjects are 12, 45, and 125, respectively.

As a method to carry out the invention, I suggest to use the combination of LookUp Tables (LUTs). The general schema of invention realized by means of LUTs is shown in FIG. 10. The term Hierarchical LUT in FIG. 10 means that several LUTs are connected consecutively. Word hierarchical implies that each LUT represent a certain level of abstraction of information.

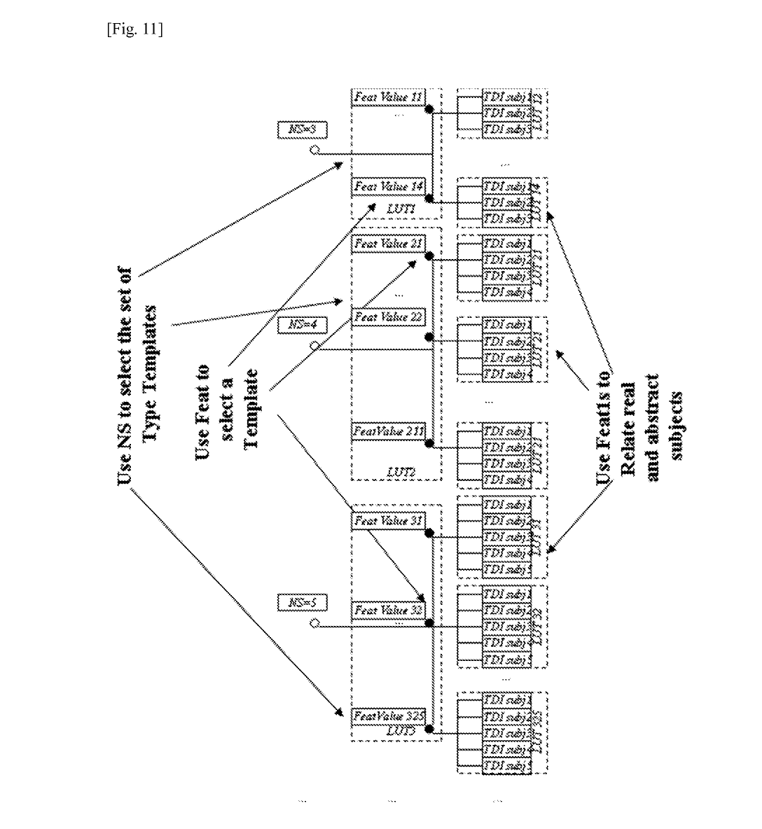

The general schema of a hierarchical LUT for RGT inference is presented in FIG. 11.

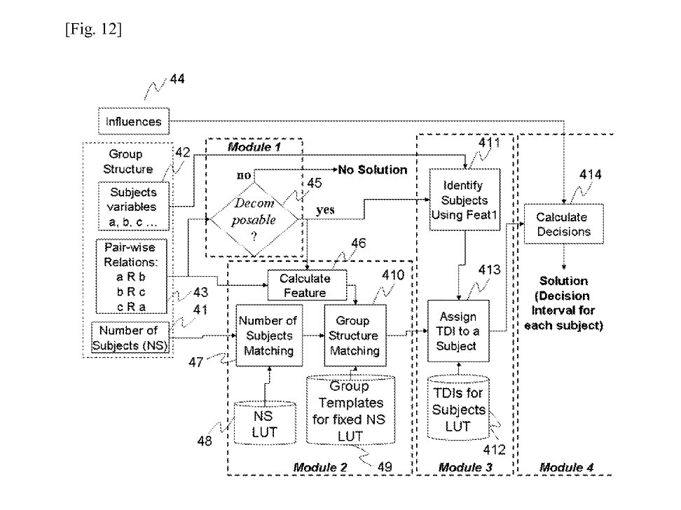

The detailed schema of the invention realized by means of LUTs is presented in FIG. 12. First, user inputs number of subjects (NS) (41), subject variables (42) and the group structure by indicating pair-wise relations (43) between subjects. Relations can take value either 0 or 1 meaning conflict or alliance, respectively. The relations are formalized in the form of pairs of subject variables: for example, ab=1, meaning subjects a and b are in alliance.

The pairs of subjects are then propagated into module (45) to check, whether the input group structure is decomposable. If the answer is “Yes”, data about the group structure are propagated into module (46). The process GT inference is stopped providing no solution, otherwise.

If input graph is decomposable, relationship pairs (ab,bc,ad, etc.) are input into the module (46) from module (43). Using relationship pairs, 4-dim is created and Feat value is calculated in module (46). Module (46) outputs Feat value.

The modules (48), (49) and (412) are storages. Module (48) contains one LUT, which contains distinct numbers of subjects, associated with the Feat values for graph types (FIG. 11). The LUTs of Feat value for graph types are stored in module (49). In storage (48) the numbers of subjects are associates with particular LUTs in module (49). Therefore output of module (48) is the reference to a particular LUT in module (49).

In module (49), each LUT contains the Feat values associated with a particular set of TDIs. The TDIs for each Feat value are stored in module (412) in separate LUTs. Each LUT in module (412) contains NoS for each abstract subject and corresponding TDI. Therefore, module (49) outputs the reference a particular LUT in module (412).

Module (47) takes two inputs from the module (41) and module (48). Module (47) outputs the reference to a certain LUT in module (49). This reference is passed to module (410).

Module (410) takes three inputs from modules (47), (46) and (49). The input from module (47) is a reference to a particular LUT in module (49). Having selected a particular LUT in module (49), module (410) uses input from module (46) to match a particular record in the LUT from module (49). Module (410) outputs the reference to a particular LUT in module (412).

The module (410) receives inputs from modules (46) and (49). Module (46) provides Feat value, while module (49) is a LUT of group templates. Module (410) performs selection a group configuration by comparing Feat value from (46) with the ones in the LUT (49). Module (410) outputs LUT (412).

Module (411) receives inputs from modules (43) and (45) and outputs feature (NoA) value for each subject variable (a, b, c, . . . ) to module (413). The module (413) receives three inputs from modules (410), (411) and (412). The input from module (410) is used to select a particular LUT in module (412). The input from module (411) is used to related the actual subjects variables to abstract subject variables. Module (413) outputs the collection of TDIs, which are bind to particular actual subjects.

Finally, module (414) takes inputs from Influence module (44) and module (413). Module (414) calculates values of limits of TDIs, using the information about mutual inuences from module (44). Module (414) outputs solution of RGT inference.

### Example 1

### Example of Implementation in the Case of a Group of Four Members

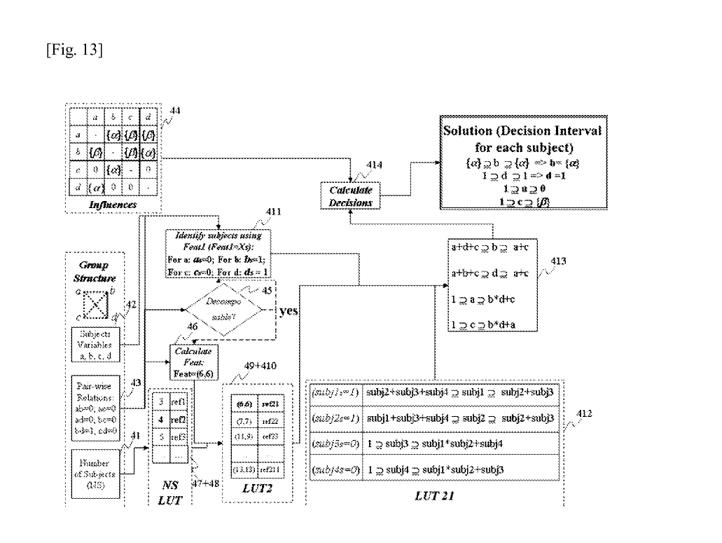

Here the example of implementation of the invention is presented. The example is presented in FIG. 13.

User inputs number of subjects NS=4 in Module (41).

User inputs subject variables a,b,c,d in Module (42).

User inputs pair-wise relationships ab=0, ac=0, ad=0, bc=0, bd=1, cd=0 in Module (43).

User inputs influences in Module (44). The Influence matrix is presented in FIG. 13 (44).

Module (45) performs checking of decomposability of the input graph. In this case, there are 4 subjects. Therefore module (45) calculates the Feat value for the input graph (Feat=(5,5)) and compares it to the (11,11), which is Feat value for non-decomposable graphs:
Feat=(5, 5)≠(11, 11).

Therefore graph is decomposable. If graph is non-decomposable, module (45) terminates RGT inference and notifies user that there is no solution, since the graph is non-decomposable. This dashed-line arrows in FIG. 13 indicate that module (45) do not terminate the RGT inference.

Module (45) takes pairs of of relationships as input from (43). Then NoA (xs, where x is either a, b, c, d) for each subject is calculated: as=0, bs=1, cs=0 and ds=1. Using as=0, bs=1, cs=0 and ds=1, the Feat value is calculated: Feat=(5,5). Feat value (5,5) is sent to module (49+410).

Module (41) sends NS=3 value to module (47). Module (48) contains LUT, which finds a reference to a particular LUT in module (410). The operation of selecting a record from LUT and sending reference (ref2) to the module (410) is indicated as disjunction of the modules (47) and (48) into one module (47+48). Module (47+48) sends a reference ref21 to the module (410).

Module (411) receives inputs from modules (43) outputs Feat1 (NoA) value for each subject variable to module (413).

The module (413) receives two inputs from modules (410), (411) and (412). The input from module (49+410) is used to select a certain LUT in module (412). For simplicity of presentation, only LUT corresponding to the ref21 is shown in module (412). In such case, subj1=b, subj2=d, subj3=a and subj4=c. The input from module (411) is then used to related actual subject variables and TDIs. The resulting decision intervals for each subject are shown in module (413).

Finally, module (414) takes inputs from Influence module (44) and module (413). Module (414) calculates values of limits of decision intervals, using the information about mutual influences from module (44). Module (414) outputs solution of RGT inference.

### INDUSTRIAL APPLICABILITY

The present invention assists the Reflexive Game Theory (RGT) inference by allowing the user to input data required for conventional RGT inference.

Another application is to provide analysis of the group behavior based on the relationships between the subjects in a group and their mutual influences.

### REFERENCE SIGNS LIST

1, 2, 3, 4 Module

1. A method of performing Reflexive Game Theory (RGT) inference comprising:
pre-computing of possible group structure and real-time selecting (template matching) of the group templates by using the input information.

2. A method according to claim 1,
wherein the pre-computing process pre-computes the templates for template matching-based Reflexive Game Theory (RGT) inference based on using templates of the groups, and the templates are obtained by generalization of the possible group structures.

3. A method according to claim 2,
wherein the combinatorial techniques are applied to obtain pre-computed templates, and the combinatorial technique are applied to obtain all possible different group types.

4. A method of processing the actual input data for RGT inference by using pre-computed templates comprising:
identifying a certain template corresponding to the input data by unique structure features; and
identifying location of each subject by means of position feature.

5. The method according to claim 4,
wherein algebraic features are computed for identification of a corresponding group template.

6. The method according to claim 4,
wherein algebraic features are computed for identification of a location of each subject in a group.

7. A system of performing Reflexive Game Theory (RGT) inference comprising:
pre-computing module that pre-computes possible group structure, and
real-time selecting module that real-time selects (template matching) the group templates by using the input information.

8. A system according to claim 7,
wherein the pre-computing module pre-computes the templates for template matching-based Reflexive Game Theory (RGT) inference based on using templates of the groups, and the templates are obtained by generalization of the possible group structures.

9. A system according to claim 8,
wherein the combinatorial techniques are applied to obtain pre-computed templates, and the combinatorial technique are applied to obtain all possible different group types.

10. A system of processing the actual input data for RGT inference by using pre-computed templates comprising:
module that identifies a certain template corresponding to the input data by unique structure features; and
module that identifies location of each subject by means of position feature.

11. A system according to claim 10,
wherein the module computes algebraic features for identification of a corresponding group template.

12. The system according to claim 10,
wherein the module computes algebraic features for identification of a location of each subject in a group.
